(19) United States
(12) Patent Application Publication
(10) Pub. No.: US 2023/0345429 A1
(43) Pub. Date: Oct. 26, 2023

(54) OVERLAPPING RESOURCE POOLS IN SIDELINK COMMUNICATION

(71) Applicant: QUALCOMM Incorporated, San Diego, CA (US)

(72) Inventors: Chih-Hao LIU, San Diego, CA (US); Jing SUN, San Diego, CA (US); Yisheng XUE, San Diego, CA (US); Giovanni CHISCI, San Diego, CA (US); Xiaoxia ZHANG, San Diego, CA (US)

(21) Appl. No.: 17/660,613

(22) Filed: Apr. 25, 2022

(51) Int. Cl. H04W 72/04; H04W 72/08; H04W 74/08

(52) U.S. Cl. CPC H04W 72/0446; H04W 72/082; H04W 72/0406; H04W 74/0808

(57) ABSTRACT

Wireless communications systems, apparatuses, and methods are provided. A method of wireless communication performed by a first sidelink user equipment (UE) may include monitoring a first resource pool (RP) associated with a slot, monitoring a second RP associated with one or more sub-slots, wherein the second RP at least partially overlaps the first RP, receiving, from a second sidelink UE, an indicator indicating a selection of the first RP or the second RP, and receiving, from the second sidelink UE, a communication via the first RP or the second RP based on the indicator.

### TECHNICAL FIELD

This application relates to wireless communication systems, and more particularly, to overlapping resource pools in sidelink communication.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE) may include monitoring a first resource pool (RP) associated with a slot; monitoring a second RP associated with one or more sub-slots, wherein the second RP at least partially overlaps the first RP; receiving, from a second sidelink UE, an indicator indicating a selection of the first RP or the second RP; and receiving, from the second sidelink UE, a communication via the first RP or the second RP based on the indicator.

In an additional aspect of the disclosure, a method of wireless communication performed by a first sidelink user equipment (UE) may include performing a listen-before-talk (LBT) procedure in a shared frequency band; selecting, based on the LBT procedure being successful, a first resource pool (RP) or a second RP, wherein the second RP at least partially overlaps the first RP; transmitting, to a second sidelink UE, an indicator indicating the selected first RP or the selected second RP; and transmitting, to the second sidelink UE, a communication based on the indicator.

In an additional aspect of the disclosure, a first sidelink user equipment (UE) may include a memory; a transceiver; and at least one processor coupled to the memory and the transceiver, wherein the first sidelink UE is configured to monitor a first resource pool (RP) associated with a slot; monitor a second RP associated with one or more sub-slots, wherein the second RP at least partially overlaps the first RP; receive, from a second sidelink UE, an indicator indicating a selection of the first RP or the second RP; and receive, from the second sidelink UE, a communication via the first RP or the second RP based on the indicator.

In an additional aspect of the disclosure, a first sidelink user equipment (UE) may include a memory; a transceiver; and at least one processor coupled to the memory and the transceiver, wherein the first sidelink UE is configured to perform a listen-before-talk (LBT) procedure in a shared frequency band; select, based on the LBT procedure being successful, a first resource pool (RP) or a second RP, wherein the second RP at least partially overlaps the first RP; transmit, to a second sidelink UE, an indicator indicating the selected first RP or the selected second RP; and transmit, to the second sidelink UE, a communication based on the indicator.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIGS. 3A-3G illustrate examples of overlapping resource pools in sidelink communication according to some aspects of the present disclosure.

FIG. 4 illustrates an example of overlapping resources in sidelink communication according to some aspects of the present disclosure.

FIG. 5 is a signaling diagram of a wireless communication method according to some aspects of the present disclosure.

FIG. 6 is a block diagram of an exemplary user equipment (UE) according to some aspects of the present disclosure.

FIG. 7 is a block diagram of an exemplary network unit according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNIT) radio band has a minimum OCB requirement of about at least 70 percent (%).

Some sidelink systems may operate over a 20 MHz bandwidth, e.g., for listen before talk (LBT) based channel accessing, in an unlicensed band. ABS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannels in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

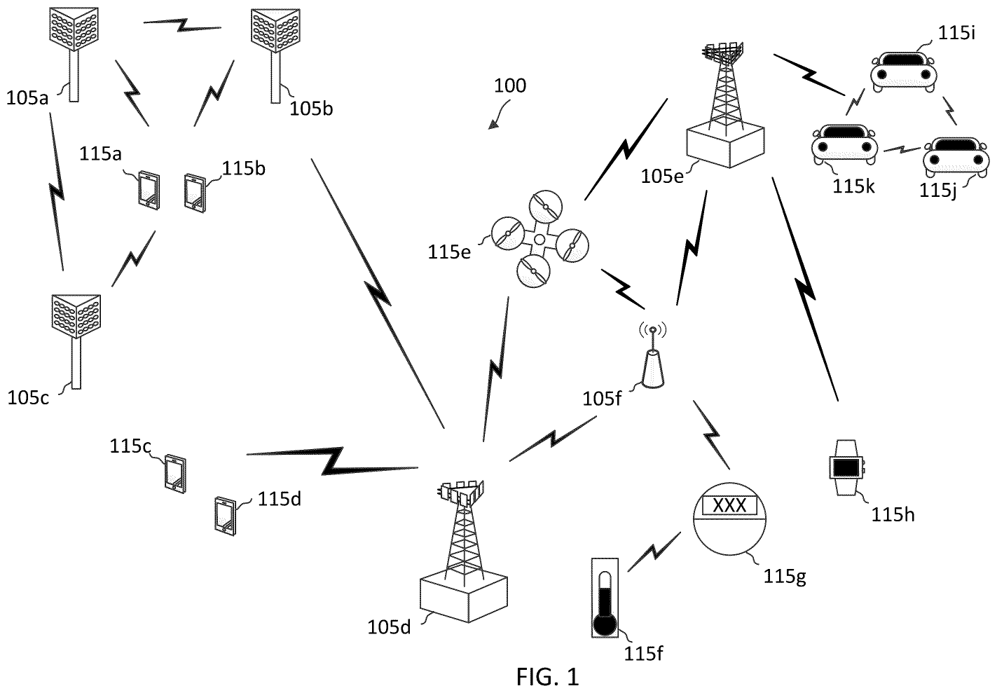

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

ABS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. ABS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115j may monitor a first resource pool (RP) associated with a slot. The UE 115j may monitor a second RP associated with one or more sub-slots. The second RP may at least partially overlap the first RP. The UE 115j may receive, from the UE 115k, an indicator indicating a selection of the first RP or the second RP. The UE 115j may receive, from the UE 115k, a communication based on the indicator.

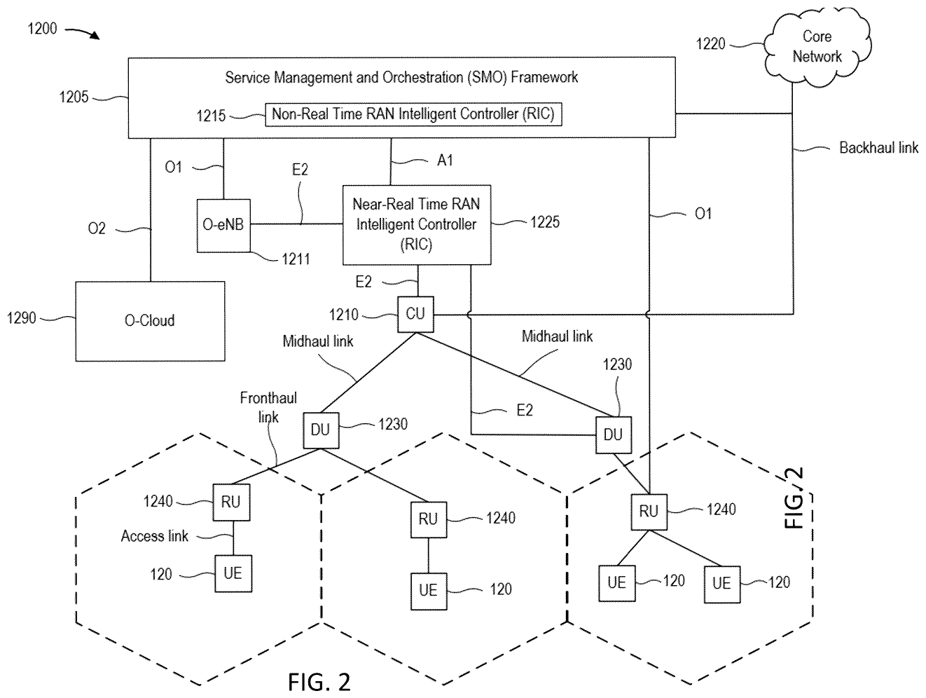

FIG. 2 shows a diagram illustrating an example disaggregated base station 1200 architecture. The disaggregated base station 1200 architecture may include one or more central units (CUs) 1210 that can communicate directly with a core network 1220 via a backhaul link, or indirectly with the core network 1220 through one or more disaggregated base station units (such as a Near-Real Time (Near-RT) RAN Intelligent Controller (RIC) 1225 via an E2 link, or a Non-Real Time (Non-RT) RIC 1215 associated with a Service Management and Orchestration (SMO) Framework 1205, or both). A CU 1210 may communicate with one or more distributed units (DUs) 1230 via respective midhaul links, such as an F1 interface. The DUs 1230 may communicate with one or more radio units (RUs) 1240 via respective fronthaul links. The RUs 1240 may communicate with respective UEs 120 via one or more radio frequency (RF) access links. In some implementations, the UE 120 may be simultaneously served by multiple RUs 1240.

Each of the units, i.e., the CUs 1210, the DUs 1230, the RUs 1240, as well as the Near-RT RICs 1225, the Non-RT RICs 1215 and the SMO Framework 1205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1210. The CU 1210 may be configured to handle user plane functionality (i.e., Central Unit-User Plane (CU-UP)), control plane functionality (i.e., Central Unit-Control Plane (CU-CP)), or a combination thereof. In some implementations, the CU 1210 can be logically split into one or more CU-UP units and one or more CU-CP units. The CU-UP unit can communicate bidirectionally with the CU-CP unit via an interface, such as the E1 interface when implemented in an O-RAN configuration. The CU 1210 can be implemented to communicate with the DU 1230, as necessary, for network control and signaling.

The DU 1230 may correspond to a logical unit that includes one or more base station functions to control the operation of one or more RUs 1240. In some aspects, the DU 1230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1230 may further host one or more low PHY layers. Each layer (or module) can be implemented with an interface configured to communicate signals with other layers (and modules) hosted by the DU 1230, or with the control functions hosted by the CU 1210.

Lower-layer functionality can be implemented by one or more RUs 1240. In some deployments, an RU 1240, controlled by a DU 1230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1240 can be implemented to handle over the air (OTA) communication with one or more UEs 120. In some implementations, real-time and non-real-time aspects of control and user plane communication with the RU(s) 1240 can be controlled by the corresponding DU 1230. In some scenarios, this configuration can enable the DU(s) 1230 and the CU 1210 to be implemented in a cloud-based RAN architecture, such as a vRAN architecture.

The SMO Framework 1205 may be configured to support RAN deployment and provisioning of non-virtualized and virtualized network elements. For non-virtualized network elements, the SMO Framework 1205 may be configured to support the deployment of dedicated physical resources for RAN coverage requirements which may be managed via an operations and maintenance interface (such as an O1 interface). For virtualized network elements, the SMO Framework 1205 may be configured to interact with a cloud computing platform (such as an open cloud (O-Cloud) 1290) to perform network element life cycle management (such as to instantiate virtualized network elements) via a cloud computing platform interface (such as an O2 interface). Such virtualized network elements can include, but are not limited to, CUs 1210, DUs 1230, RUs 1240 and Near-RT RICs 1225. In some implementations, the SMO Framework 1205 can communicate with a hardware aspect of a 4G RAN, such as an open eNB (O-eNB) 1211, via an OI interface. Additionally, in some implementations, the SMO Framework 1205 can communicate directly with one or more RUs 1240 via an O1 interface. The SMO Framework 1205 also may include a Non-RT RIC 1215 configured to support functionality of the SMO Framework 1205.

The Non-RT RIC 1215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1225. The Non-RT RIC 1215 may be coupled to or communicate with (such as via an Al interface) the Near-RT RIC 1225. The Near-RT RIC 1225 may be configured to include a logical function that enables near-real-time control and optimization of RAN elements and resources via data collection and actions over an interface (such as via an E2 interface) connecting one or more CUs 1210, one or more DUs 1230, or both, as well as an O-eNB, with the Near-RT RIC 1225.

In some implementations, to generate AI/ML models to be deployed in the Near-RT RIC 1225, the Non-RT RIC 1215 may receive parameters or external enrichment information from external servers. Such information may be utilized by the Near-RT RIC 1225 and may be received at the SMO Framework 1205 or the Non-RT RIC 1215 from non-network data sources or from network functions. In some examples, the Non-RT RIC 1215 or the Near-RT RIC 1225 may be configured to tune RAN behavior or performance. For example, the Non-RT RIC 1215 may monitor long-term trends and patterns for performance and employ AI/ML models to perform corrective actions through the SMO Framework 1205 (such as reconfiguration via 01) or via creation of RAN management policies (such as Al policies).

In some aspects, a first UE 120 monitor a first resource pool (RP) associated with a slot. The first UE 120 may monitor a second RP associated with one or more sub-slots. The second RP may at least partially overlap the first RP. The first UE 120 may receive, from a second UE 120, an indicator indicating a selection of the first RP or the second RP. The first UE 120 may receive, from the second UE 120, a communication based on the indicator.

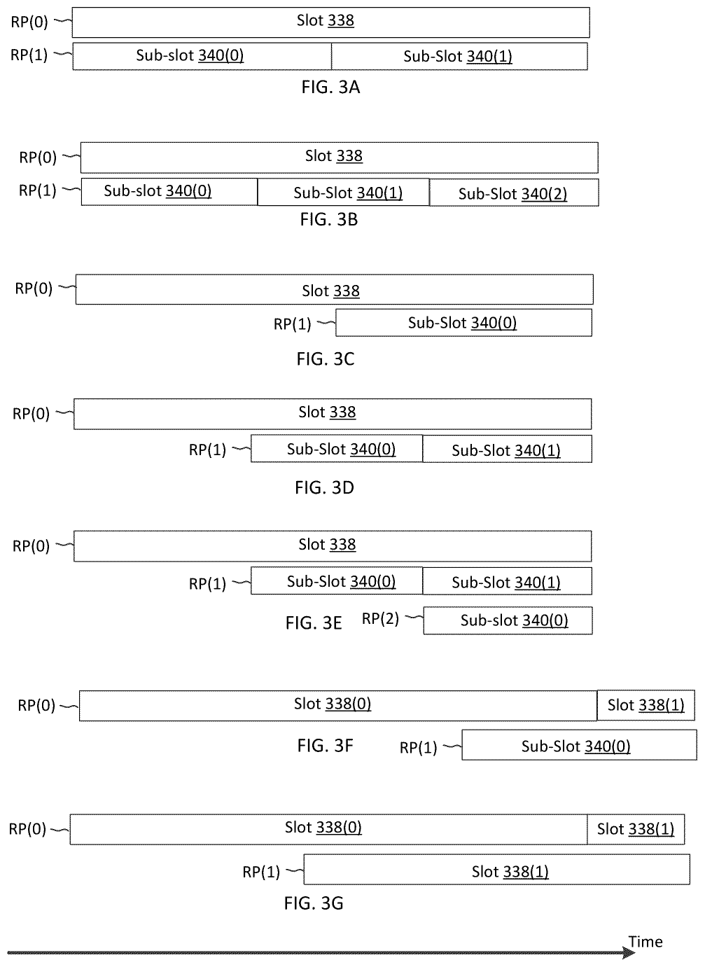

FIGS. 3A-3G illustrate examples of resource configurations that support overlapping resource pools in sidelink communication in accordance with some aspects of the present disclosure. The resource configurations may be implemented by aspects of the wireless communications network 100 and/or the wireless communications network 1200. For example, the resource configurations may be implemented for sidelink communications by one or more UEs, (e.g., UE 115, UE 120, or UE 600) such as described by the wireless communications network 100 and/or 1200. In FIGS. 3A-3G, the x-axis represents time in some arbitrary units.

In some aspects, a first sidelink UE (e.g., the UE 115, the UE 120, or the UE 600) may monitor RP(0) associated with a slot 338 and/or RP(1) associated with one or more sub-slots 340. The first sidelink UE may receive a configured grant (e.g., a dynamic grant) indicating the RP(0) and/or the RP(1) from a network unit (e.g., the BS 105, the RU 1240, the DU 1230, the CU 1210, or the network unit 700). In this regard, the first sidelink UE may operate in sidelink mode 1 and receive the configured grant for the RP(0) and/or the RP(1) in an RRC message and/or a DCI message (e.g., a DCI-3 message, a DCI-1 message). In some aspects, a single configured grant may indicate the RP(0) and the RP(1). In some aspects, a first configured grant may indicate the RP(0) and a second configured grant may indicate the RP(1). The RP(0) may indicate time/frequency resources associated with a slot 338 allocated to the first sidelink UE. The RP(1) may indicate time/frequency resources associated with one or more sub-slots 340 allocated to the first sidelink UE. The frequency resources may include a frequency spectrum, a frequency band, a frequency sub-band, a frequency subchannel, resource elements, resource blocks, and/or a frequency interlace.

In some aspects, a slot 338 may be partitioned into sub-slots 340 such that each sub-slot 340 occupies multiple symbols within the slot 338. For example, a slot 338 may include 2, 3, 4, or more sub-slots 340. In some instances, a slot 338 may include 14 symbols. A sub-slot 340 may occupy 2, 3, 4, 5, 6, or more symbols. In some aspects, each sub-slot 340 may occupy contiguous symbols (e.g., symbols 0-6 or symbols 7-13) within the slot 338. By partitioning a slot 338 into sub-slots 340 the second UE (e.g., the sidelink transmitting UE) may increase the number of potential starting positions of a COT based on increasing the number of LBT procedures that may be performed per slot 338.

In some aspects, the RP(1) may at least partially overlap (e.g., partially overlap in time) the RP(0). For example, the one or more sub-slots 340 may overlap only with symbols of the slot 338 of the RP(0). In other words, no symbols of the sub-slot 340 of the RP(1) are outside the symbols of the slot 338 of the RP(0). The one or more sub-slots 340 of the RP(1) may overlap at least one leading symbol of the slot 338 of the RP(0). In some aspects, all symbols of the sub-slot 340 of the RP(1) overlap with the leading symbols of the slot 338 of the RP(0). For example, the sub-slot 340 of the RP(1) may occupy symbol indexes 0 to x that overlap with symbol indexes 0 to x of the slot 338 of the RP(0). In some aspects, the one or more sub-slots 340 of the RP(1) overlap at least one trailing symbol of the slot 338 of the RP(0). For example, the sub-slot 340 of the RP(1) may occupy symbol indexes x to 13 that overlap with symbol indexes x to 13 of the slot 338 of the RP(0). In some aspects, the one or more sub-slots 340 of the RP(1) may overlap at least one trailing symbol of the slot 338 of the RP(0) and at least one leading symbol of an adjacent slot 338. For example, the leading symbols of the sub-slot 340 of the RP(1) may overlap with the trailing symbols of the slot 338 of the RP(0) while the trailing symbols of the sub-slot 340 of the RP(1) may overlap the leading symbols of another slot 338 adjacent to the slot 338 of the RP(0).

As shown in FIG. 3A, the symbols of slot 338 of RP(0) may completely overlap with the symbols of sub-slot 340(1) and sub-slot 340(2) of RP (1). In some aspects, the sub-slots 340 may include an equal number of symbols. For example, each of sub-slots 340(0) and 340(1) may include seven symbols. Symbol indexes 0 to 6 of sub-slot 340(0) may overlap with symbol indexes 0 to 6 of slot 338 while symbol indexes 0 to 6 of sub-slot 340(1) may overlap with symbol indexes 7 to 13 of slot 338.

As shown in FIG. 3B, the symbols of slot 338 of RP(0) may completely overlap with the symbols of sub-slot 340(0), sub-slot 340(1), and sub-slot 340(2) of RP (1). In some aspects, the sub-slots 340 may include an unequal number of symbols. For example, sub-slots 340(0) and 340(1) may include five symbols while sub-slot 340(2) may include 4 symbols. Symbol indexes 0 to 4 of sub-slot 340(0) may overlap with symbol indexes 0 to 4 of slot 338. Symbol indexes 0 to 4 of sub-slot 340(1) may overlap with symbol indexes 5 to 9 of slot 338. Symbol indexes 0 to 3 of sub-slot 340(2) may overlap with symbol indexes 10 to 13 of slot 338.

As shown in FIG. 3C, the symbols of slot 338 of RP(0) may partially overlap with the symbols of sub-slot 340(0) of RP (1). In some aspects, the RP(1) may include a single sub-slot 340(0) that may not begin at the same time as the slot 338. For example, sub-slot 340(0) may overlap the trailing symbols of slot 338.

As shown in FIG. 3D, the symbols of slot 338 of RP(0) may partially overlap with the symbols of sub-slot 340(0) and sub-slot 340(1) of RP (1). In some aspects, the RP(1) may include two sub-slots 340(0) and 340(1) that may not begin at the same time as the slot 338. For example, sub-slot 340(0) and sub-slot 340(1) may overlap the trailing symbols of slot 338.

As shown in FIG. 3E, in some aspects, the configured grant may include more than two RPs. For example, RP(0) may include slot 338. RP(1) may include sub-slots 340(0) and 340(1) overlapping the trailing symbols of slot 338. A third RP(2) may include sub-slot 340(0) overlapping sub-slot 340(1) of the second RP and overlapping the trailing symbols of slot 338 of the first RP(0).

As shown in FIG. 3F, the symbols of slot 338 of RP(0) may partially overlap with the symbols of sub-slot 340(0) of RP (1). In some aspects, the second RP may include a sub-slot 340(0) that overlaps the trailing symbols of slot 338(0) and the leading symbols of the next slot 338(1).

As shown in FIG. 3G, the trailing symbols of slot 338(0) of RP(0) may overlap with the leading symbols of the slot 338(1) of the RP(1) while the leading symbols of another adjacent slot 338(1) of RP(0) may overlap the trailing symbols of slot 338(1) of RP(1).

In some aspects, the first sidelink UE may simultaneously monitor the RP(0) associated with the slot 338 and the RP(1) associated with the one or more sub-slots 340 for a PSCCH communication (e.g., an SCI in the PSCCH communication). In some aspects, the first sidelink UE may simultaneously monitor the RP(0) associated with the slot 338 and the RP(1) associated with the one or more sub-slots 340 based on a number of the one or more sub-slots 340. The RP(1) may include one or more sub-slots 340. The first sidelink UE may be configured with a capability to monitor all of the one or more sub-slots 340. For example, the first sidelink UE may be configured with computing resources (e.g., CPU capability, memory capability, etc.) and/or power resources (e.g., battery power, line power, etc.) sufficient to monitor all of the one or more sub-slots 340 of the RP(1). In some aspects, the first sidelink UE may not be configured with sufficient computing resources and/or power resources to monitor all of the one or more sub-slots 340 in the RP(1). For example, the first sidelink UE may be configured with computing resources sufficient to only monitor one of the sub-slots 340.

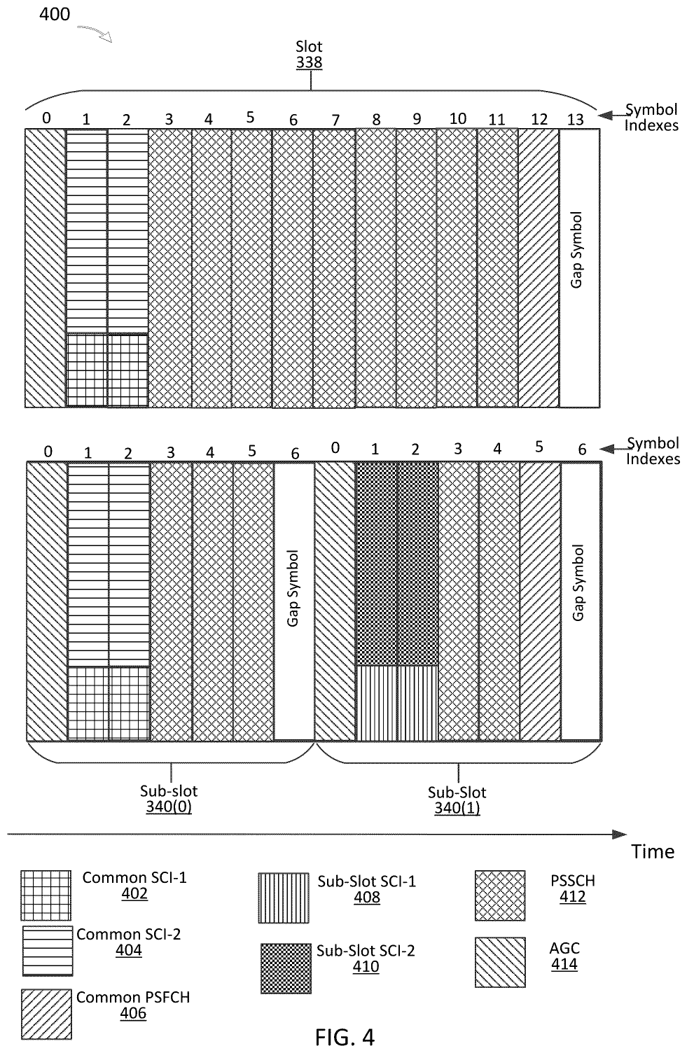

FIG. 4 illustrates an example of overlapping resources 400 in sidelink communication according to some aspects of the present disclosure. In some aspects, the first RP and the second RP may share common resources associated with a physical sidelink feedback channel (PSFCH) 406. The PSFCH 406 carrying HARQ feedback in the first RP may share common time resources (e.g., the same symbol(s) and/or subchannel(s)) with the PSFCH 406 carrying HARQ feedback in the second RP. For example, the PSFCH 406 in symbol 12 of the slot 338 may share common resources in overlapping symbol 5 of the sub-slot 340(1). The first RP and the second RP may share common a common PSFCH periodicity. In some aspects, the first RP and the second RP may share common frequency resources for the PSFCH. Additionally or alternatively, the frequency resources of the PSFCH in the first RP may be multiplexed (e.g., frequency division multiplexed) with the frequency resources of the PSFCH in the second RP. The first sidelink UE and the second sidelink UE may receive an indication of the first RP and the second RP in a configured grant (e.g., a dynamic configured grant) from a network unit (e.g., the BS 105, the RU 1240, the DU 1230, the CU 1210, or the network unit 700). The configured grant may indicate the resource elements of the common SCI-1, the common SCI-2, and/or the common PSFCH.

In some aspects, the first RP and the second RP may share common resources associated with sidelink control information (SCI). For example, the PSCCH carrying the SCI-1 402 in symbols 1 and 2 of the slot 338 may share common resource elements (e.g., the same symbol(s) and/or subchannel(s)) with the PSCCH carrying the SCI-1 402 in symbols 1 and 2 of the sub-slot 340(0). Since the slot 338 in the first RP only carries a single SCI-1 402, the first RP and the second RP may share a single set of common resources associated with the SCI-1 402. In this manner, the first sidelink UE may decode the SCI-1 402 using a single set of common resource elements in symbols 1 and 2.

The common SCI-1 402 may indicate the resources (e.g., AGC symbol 414, PSSCH 412 length, sub-slot 340 length) of the selected RP. In some aspects, the SCI-1 402 may indicate the selected RP as a codepoint, an information element, or other suitable indicator. In some aspects, the indicator may be a binary indicator (e.g., a single bit “0” or “1”). For example, the indicator value of “0” may indicate to use the first RP, whereas an indicator of “1” may indicate to use the second RP. Alternatively, the indicator value of “0” may indicate to use the second RP, whereas an indicator of “1” may indicate to use the first RP. In some aspects, the SCI-1 402 may indicate the selected RP using different cyclic redundancy check (CRC) scrambling of the SCI-1 402. By using a common SCI-1 402 and indicating the dynamic PSSCH length in the SCI-1 402, a low capability sidelink UE may be able to decode a full slot of the first RP and a leading sub-slot 340(0) of the second RP (e.g., a sub-slot 340(0) of the second RP that has symbols 0-6 overlapping the leading symbols of the slot 338). By using a common SCI-1 402 and indicating the dynamic PSSCH length in the SCI-1 402, a high capability sidelink UE monitoring both the first RP and the second RP may perform a single SCI-1 402 decoding.

The first sidelink UE may receive a common SCI-2 404 (e.g., common resources in the first RP and the second RP) to indicate whether the selected RP is the first RP or the second RP. In some aspects, the PSSCH carrying the SCI-2 404 in the first RP in symbols 1 and 2 may share common resource elements (e.g., the same symbol(s) and/or subchannel(s)) with the PSSCH carrying the SCI-2 404 in the second RP. Since the slot 338 in the first RP only carries a single SCI-2 404, the first RP and the second RP may share a single set of common resources in symbols 1 and 2 associated with the SCI-2 404. In this manner, the first sidelink UE may decode the SCI-2 404 using a single set of common resource elements. Sharing common resources between the slot 338 of the first RP and the leading sub-slot 340(0) of the second RP for the SCI-1 402 and/or SCI-2 404 may reduce computing resources and/or power consumption in the first sidelink UE.

The first sidelink UE may need to know the number of PSSCH resources (e.g., number of symbols) carrying the common SCI-2 404 after the first sidelink UE decodes the common SCI-1 402. The common SCI-1 402 may include an indication (e.g., a number of symbols) of the PSSCH resources carrying the common SCI-2 404. The first sidelink UE may receive the indicator from the second sidelink UE to use the first RP or the second RP via the common SCI-1 402 or the common SCI-2 404. The second sidelink UE may transmit the RP indicator to the first sidelink UE via the common SCI-1 402 or the common SCI-2 404 based on the number of sub-slots 340 in the second RP. For example, if the second RP includes two sub-slots 340(0) and 340(1) as shown in FIG. 4, the RP indicator may be carried by the SCI-1 402. If the second RP includes more than two sub-slots 340, then the RP indicator may be carried by the SCI-2 404.

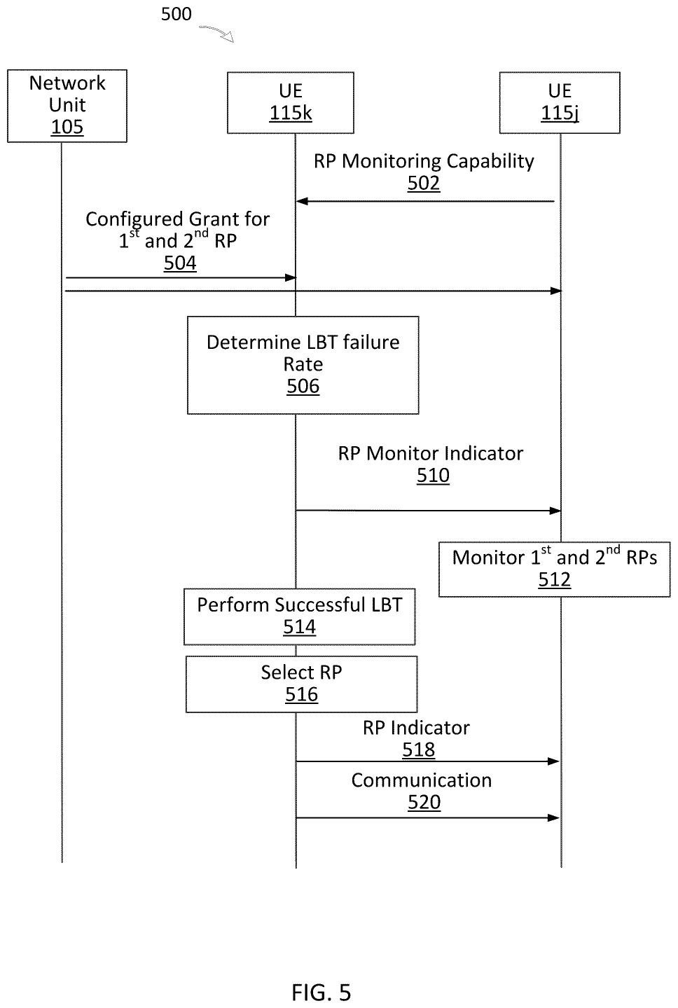

FIG. 5 is a signaling diagram of a wireless communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115, UE 120, or UE 600, may utilize one or more components, such as the processor 602, the memory 604, the sidelink resource pool module 608, the transceiver 610, the modem 612, and the one or more antennas 616, to execute aspects of method 500. A wireless communication device, such as the BS 105, the CU 1210, the DU 1230, the RU 1240, and/or the network unit 700 may utilize one or more components, such as the processor 702, the memory 704, the sidelink resource pool module 708, the transceiver 710, the modem 712, and the one or more antennas 716, to execute aspects of method 500.

At action 502, the UE 115j may transmit an indicator to the UE 115k indicating resource pool (RP) monitoring capability. In some aspects, the 115j may be configured with a capability to simultaneously monitor multiple resource pools. For example, the 115j may be configured with a capability to monitor the first RP and all of one or more sub-slots in the second RP. The 115j may be configured with computing resources (e.g., CPU capability, memory capability, etc.) and/or power resources (e.g., battery power, line power, etc.) sufficient to monitor all of the sub-slots of the second RP. In some aspects, the 115j may not be configured with sufficient computing resources and/or power resources to monitor all of the sub-slots in the second RP. For example, the 115j may be configured with computing resources sufficient to only monitor one of the sub-slots of the second RP.

At action 504, the network unit 105 may transmit a configured grant for the first RP and the second RP to the UE 115k and the UE 115j. In this regard, network unit 105 and UEs 115j and 115k may operate in sidelink mode 1. The network unit 105 may transmit the configured grant for the first RP and the second RP in an RRC message and/or a DCI message (e.g., a DCI-3 message, a DCI-1 message). The first RP may be associated with a slot. The second may be associated with one or more sub-slots. The first RP and the second RP may indicate time/frequency resources allocated to the UE 115j and the UE 115k. The frequency resources may include a frequency spectrum, a frequency band, a frequency sub-band, a frequency subchannel, resource elements, resource blocks, and/or a frequency interlace.

At action 506, the UE 115k may determine an LBT failure rate. In some aspects, the UE 115j may monitor the first RP and/or the second RP based on an interference level associated with the UE 115k. The UE 115k may intend to transmit a communication to the UE 115j in an unlicensed (e.g., shared) frequency band. The UE 115k may be exposed to radio frequency interference from surrounding devices (e.g., other sidelink UEs, WiFi devices). The interference level may be high enough to prevent the UE 115k from gaining access to the COT channel at the beginning of a slot. In response, the UE 115k may perform one or more LBTs before the one or more sub-slots of the second RP in order to increase the probability of a successful LBT and gaining the COT. However, when the interference level is below the threshold, the UE 115k may be able to perform a successful LBT before the slot boundary enabling the UE 115k to gain the COT and transmit a communication to the UE 115j.

If the LBT is unsuccessful, then the UE 115k may wait a period of time (e.g., a backoff time period) to perform another LBT. The number of unsuccessful LBTs in a time period may indicate the LBT failure rate. When the LBT failure rate associated with the first RP (e.g., full slots comprising 13 or 14 symbols) is greater than a threshold, the UE 115k may select the second RP with one or more sub-slots in order to have more opportunities to perform a successful LBT. Since the LBT is performed prior to a slot boundary or a sub-slot boundary, the second RP with one or more sub-slots may increase the number of times the UE 115k may attempt an LBT to gain the channel. When the LBT failure rate associated with the first RP is less than or equal to the threshold, the UE 115k may select the first RP. In some aspects, the failure rate threshold may be pre-configured in the UE 115k. Additionally or alternatively, the UE 115k may receive an LBT failure rate threshold from the network unit 105. In this regard, the UE 115k may receive the LBT failure rate threshold via DCI, a RRC message, a PDCCH message, a PDSCH message, or other suitable communication.

At action 510, the UE 115k may transmit an RP monitor indicator to the UE 115j indicating to the UE 115j to monitor or not monitor the second RP based on the LBT failure rate. For example, when the UE 115k determines that the LBT failure rate is greater than a threshold, the UE 115k may transmit an indicator to monitor the first RP and the second RP. When the UE 115k determines that the LBT failure rate is less than or equal to the threshold, the UE 115k may transmit an indicator to monitor only the first RP. In this regard, the UE 115k may transmit the indicator to monitor the second RP via an RRC message (e.g., an RRC reconfiguration message), an SCI-1 message, an SCI-2 message, a MAC-CE message, or other suitable communication. Additionally or alternatively, the network unit 105 may transmit an indicator to the UE 115j to monitor or not monitor the second RP. In this regard, the network unit 105 may transmit the indicator to monitor or not monitor the second RP to the UE 115j via DCI, a RRC message, a PDCCH message, a PDSCH message, or other suitable communication.

At action 512, the UE 115j may simultaneously monitor the first RP and the second RP based on receiving the indicator at action 510 to monitor both the first RP and the second RP.

At action 514, the UE 115k may perform a successful LBT (e.g., a CAT 4 LBT, a CAT 3 LBT, or a CAT 2 LBT) prior to the slot or the sub-slot.

At action 516, the UE 115k may select a RP. The UE 115k may select the first RP or the second RP based on when the LBT was successful. For example, when the LBT is successful prior to the slot, the UE 115k may select the first RP. When the LBT is unsuccessful prior to the slot but a subsequent LBT is successful prior to a sub-slot, the UE 115k may select the second RP.

At action 516, the UE 115k may transmit the RP indicator to the UE 115j. In this regard, the UE 115k may transmit the indicator of the selected RP to the UE 115k using SCI. In some aspects, the RP indicator may be a binary indicator (e.g., a single bit “0” or “1”). For example, the RP indicator value of “0” may indicate to use the first RP, whereas an indicator of “1” may indicate to use the second RP. Alternatively, the indicator value of “0” may indicate to use the second RP, whereas an indicator of “1” may indicate to use the first RP. In some aspects, the SCI-1 may indicate the selected RP using different cyclic redundancy check (CRC) scrambling of the SCI-1. By using a common SCI-1 and indicating the dynamic PSSCH length in the SCI-1, a low capability sidelink UE may be able to decode a full slot of the first RP and a leading sub-slot of the second RP (e.g., a sub-slot of the second RP that has symbols overlapping the leading symbols of the slot). By using a common SCI-1 and indicating the dynamic PSSCH length in the SCI-1, a high capability sidelink UE monitoring both the first RP and the second RP may perform a single SCI-1 decoding.

In some aspects, the UE 115k may transmit the RP indicator via a common SCI-2 (e.g., common resources in the first RP and the second RP). In some aspects, the PSSCH carrying the SCI-2 in the first RP may share common resource elements (e.g., the same symbol(s) and/or subchannel(s)) with the PSSCH carrying the SCI-2 in the second RP. Since the slot in the first RP only carries a single SCI-2, the first RP and the second RP may share a single set of common resources associated with the SCI-2. In this manner, the UE 115j may decode the SCI-2 using a single set of common resource elements. Sharing common resources between the slot of the first RP and the leading sub-slot of the second RP for the SCI-1 and/or SCI-2 may reduce computing resources and/or power consumption in the UE 115j.

At action 520, the UE 115k may transmit a communication (e.g., a transport block) based on the RP indicator. The UE 115k may transmit a PSCCH communication, a PSSCH communication, and/or a transport block via the first RP or the second RP based on the RP indicator at action 518. In this regard, the UE 115k may transmit the communication in a slot when the first RP is indicated. The UE 115k may transmit the communication in one or more sub-slots when the second RP is indicated. The UE 115k may transmit the communication in the one or more sub-slots indicated by a common SCI-1 and/or common SCI-2. For example, the UE 115k may transmit the communication in the next sub-slot after the UE 115k has performed a successful LBT.

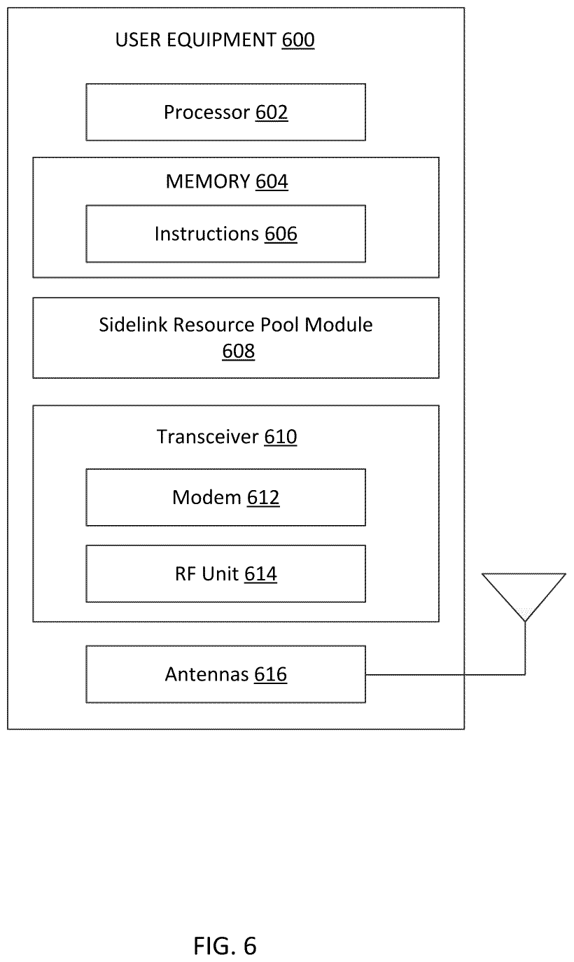

FIG. 6 is a block diagram of an exemplary UE 600 according to some aspects of the present disclosure. The UE 600 may be the UE 115 or the UE 120 in the network 100 or 1200 as discussed above. As shown, the UE 600 may include a processor 602, a memory 604, a sidelink resource pool module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 3-5. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink resource pool module 608 may be implemented via hardware, software, or combinations thereof. For example, the sidelink resource pool module 608 may be implemented as a processor, circuit, and/or instructions 606 stored in the memory 604 and executed by the processor 602. In some aspects, the sidelink resource pool module 608 may be used to monitor a first resource pool (RP) associated with a slot. The sidelink resource pool module 608 may be used to monitor a second RP associated with one or more sub-slots. The second RP may at least partially overlap the first RP. The sidelink resource pool module 608 may be used to receive, from a second sidelink UE, an indicator indicating a starting point, the starting point associated with the first RP or the second RP. The sidelink resource pool module 608 may be used to receive, from the second sidelink UE, a communication based on the indicator.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

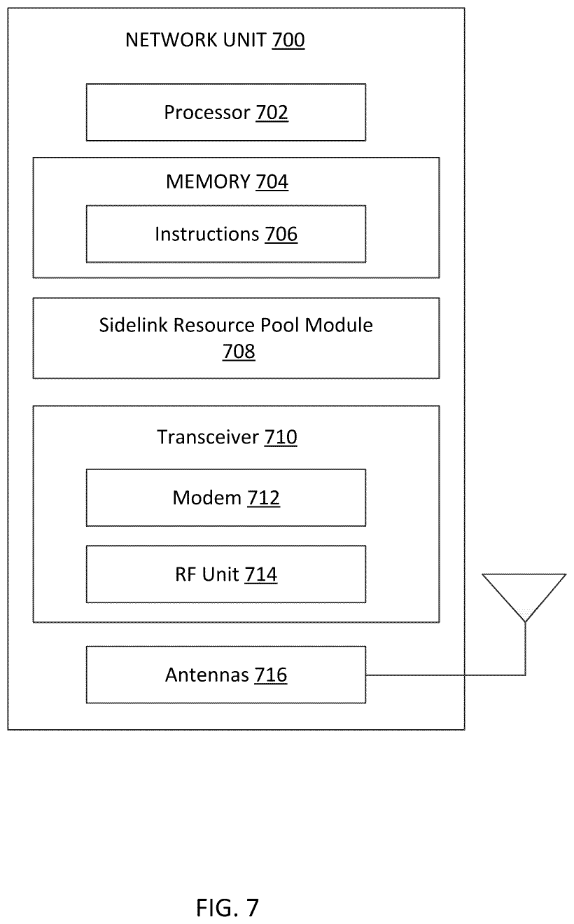

FIG. 7 is a block diagram of an exemplary network unit 700 according to some aspects of the present disclosure. The network unit 700 may be a BS 105, the CU 1210, the DU 1230, or the RU 1240, as discussed above. As shown, the network unit 700 may include a processor 702, a memory 704, a sidelink resource pool module 707, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 3-5. Instructions 706 may also be referred to as code, which may be interpreted broadly to include any type of computer-readable statement(s).

The sidelink resource pool module 708 may be implemented via hardware, software, or combinations thereof. For example, the sidelink resource pool module 708 may be implemented as a processor, circuit, and/or instructions 706 stored in the memory 704 and executed by the processor 702.

In some aspects, the sidelink resource pool module 708 may implement the aspects of FIGS. 3-5. For example, the sidelink resource pool module 708 may be used to transmit a configured grant indicating at least one of the first RP or the second RP to a UE (e.g., the UE 115, UE 120, or the UE 600). The sidelink resource pool module 708 may be used to transmit an indicator to the UE indicating to monitor the second RP, wherein the monitoring the second RP associated with the one or more sub-slots is based on the indicator.

Additionally or alternatively, the sidelink resource pool module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the network unit 700 to enable the network unit 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the network unit 700 can include multiple transceivers 710 implementing different RATs (e.g., NR and LTE). In some instances, the network unit 700 can include a single transceiver 710 implementing multiple RATs (e.g., NR and LTE). In some instances, the transceiver 710 can include various components, where different combinations of components can implement RATs.

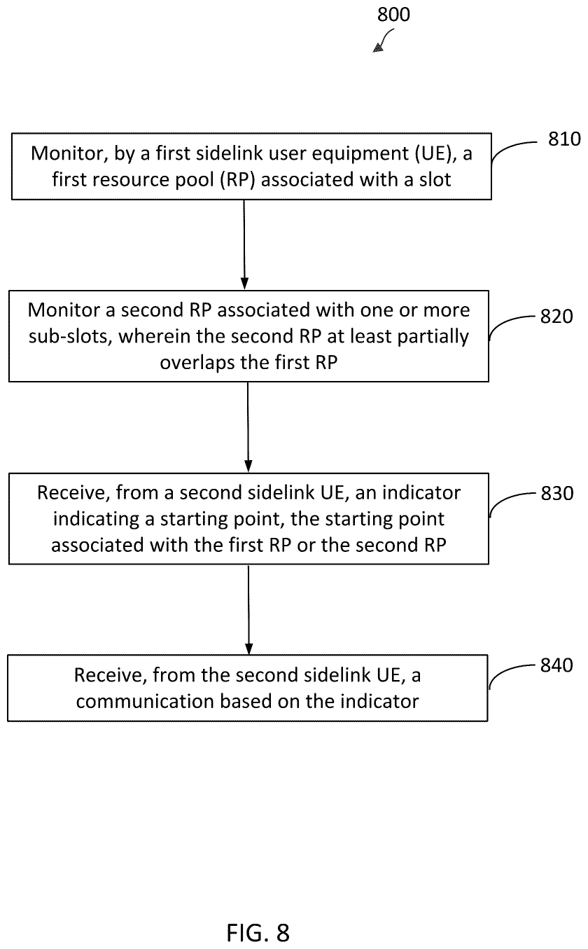

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the aspects. For example, a wireless communication device, such as the UE 115, the UE 120, or the UE 600, may utilize one or more components, such as the processor 602, the memory 604, the sidelink resource pool module 608, the transceiver 610, the modem 612, and the one or more antennas 616, to execute aspects of method 800. The method 800 may employ similar mechanisms as in the networks 100 and 1200 and the aspects and actions described with respect to FIGS. 3-5. As illustrated, the method 800 includes a number of enumerated aspects, but the method 800 may include additional aspects before, after, and in between the enumerated aspects. In some aspects, one or more of the enumerated aspects may be omitted or performed in a different order.

At action 810, the method 800 includes a first sidelink UE (e.g., the UE 115, the UE 120, or the UE 600) monitoring a first resource pool (RP) associated with a slot. The first sidelink UE may receive a configured grant (e.g., a dynamic grant) indicating the first RP from a network unit (e.g., the BS 105, the RU 1240, the DU 1230, the CU 1210, or the network unit 700). In this regard, the first sidelink UE may operate in sidelink mode 1 and receive the configured grant for the first RP in an RRC message and/or a DCI message (e.g., a DCI-3 message, a DCI-1 message). The first RP may be associated with a slot. The first RP may indicate time/frequency resources allocated to the first sidelink UE. The frequency resources may include a frequency spectrum, a frequency band, a frequency sub-band, a frequency subchannel, resource elements, resource blocks, and/or a frequency interlace.

At action 820, the method 800 includes a first sidelink UE (e.g., the UE 115, the UE 120, or the UE 600) monitoring a second resource pool (RP) associated with one or more sub-slots. The first sidelink UE may receive a configured grant (e.g., a dynamic grant) indicating the second RP from a network unit (e.g., the BS 105, the RU 1240, the DU 1230, the CU 1210, or the network unit 700). In this regard, the first sidelink UE may operate in sidelink mode 1 and receive the configured grant for the second RP in an RRC message and/or a DCI message (e.g., a DCI-3 message, a DCI-1 message). The second RP may be associated with one or more sub-slots and/or slots. In some aspects, a single configured grant may indicate the first RP and the second RP. In some aspects, a first configured grant may indicate the first RP and a second configured grant may indicate the second RP. The second RP may indicate time/frequency resources associated with one or more sub-slots allocated to the first sidelink UE. The time resources may include one or more sub-slots. The frequency resources may include a frequency spectrum, a frequency band, a frequency sub-band, a frequency subchannel, resource elements, resource blocks, and/or a frequency interlace.

In some aspects, a slot may be partitioned into sub-slots such that each sub-slot occupies multiple symbols within the slot. For example, a slot may include 2, 3, 4, or more sub-slots. In some instances, a slot may include 14 symbols. A sub-slot may occupy 2, 3, 4, 5, 6, or more symbols. In some aspects, each sub-slot may occupy contiguous symbols (e.g., symbols 0-6 or symbols 7-13) within the slot. By partitioning a slot into sub-slots the second UE may increase the number of potential starting positions of a COT based on increasing the number of LBT procedures that may be performed per slot.

In some aspects, the second RP may at least partially overlap (e.g., partially overlap in time) the first RP. For example, the one or more sub-slots may overlap only with symbols of the slot of the first RP. In other words, no symbols of the sub-slot of the second RP are outside the symbols of the slot of the first RP. The one or more sub-slots of the second RP may overlap at least one leading symbol of the slot of the first RP. In some aspects, all symbols of the sub-slot of the second RP overlap with the leading symbols of the slot of the first RP. For example, the sub-slot of the second RP may occupy symbol indexes 0 to x that overlap with symbol indexes 0 to x of the slot of the first RP. In some aspects, the one or more sub-slots of the second RP overlap at least one trailing symbol of the slot of the first RP. For example, the sub-slot of the second RP may occupy symbol indexes x to 13 that overlap with symbol indexes x to 13 of the slot of the first RP. In some aspects, the one or more sub-slots of the second RP may overlap at least one trailing symbol of the slot of the first RP and at least one leading symbol of an adjacent slot. For example, the leading symbols of the sub-slot of the second RP may overlap with the trailing symbols of the slot of the first RP while the trailing symbols of the sub-slot of the second RP may overlap the leading symbols of another slot adjacent to the slot of the first RP.

Additionally or alternatively, the first RP may include a first slot and the second RP may include a second slot. The leading symbols of the second slot may overlap with the trailing symbols of the first slot while the trailing symbols of the second slot may overlap the leading symbols of a third slot adjacent to the first slot.

In some aspects, the first sidelink UE may simultaneously monitor the first RP associated with the slot and the second RP associated with the one or more sub-slots for a PSCCH communication (e.g., an SCI in the PSCCH communication). In some aspects, the first sidelink UE may simultaneously monitor the first RP associated with the slot and the second RP associated with the one or more sub-slots based on a number of the one or more sub-slots. The second RP may include one or more sub-slots. The first sidelink UE may be configured with a capability to monitor all of the one or more sub-slots. For example, the first sidelink UE may be configured with computing resources (e.g., CPU capability, memory capability, etc.) and/or power resources (e.g., battery power, line power, etc.) sufficient to monitor all of the one or more sub-slots of the second RP. In some aspects, the first sidelink UE may not be configured with sufficient computing resources and/or power resources to monitor all of the one or more sub-slots in the second RP. For example, the first sidelink UE may be configured with computing resources sufficient to only monitor one of the sub-slots.

In some aspects, the first RP and the second RP may share common resources associated with a physical sidelink feedback channel (PSFCH). For example, the PSFCH carrying HARQ feedback in the first RP may share common time resources (e.g., the same symbol(s) and/or subchannel(s)) with the PSFCH carrying HARQ feedback in the second RP. The first RP and the second RP may share common a common PSFCH periodicity. In some aspects, the first RP and the second RP may share common frequency resources for the PSFCH. Additionally or alternatively, the frequency resources of the PSFCH in the first RP may be multiplexed (e.g., frequency division multiplexed) with the frequency resources of the PSFCH in the second RP. The first sidelink UE and the second sidelink UE may receive an indication of the first RP and the second RP in a configured grant (e.g., a dynamic configured grant) from a network unit (e.g., the BS 105, the RU 1240, the DU 1230, the CU 1210, or the network unit 700). The configured grant may indicate the resource elements of the common SCI-1, the common SCI-2, and/or the common PSFCH.

At action 830, the method 800 includes a first sidelink UE (e.g., the UE 115, the UE 120, or the UE 600) receiving, from a second sidelink UE, an indicator indicating a selection of the first RP or the second RP. The second sidelink UE may select the first RP or the second RP based on an LBT failure rate. The first sidelink UE may receive the indicator indicating the selected RP from the second sidelink UE. In this regard, the first sidelink UE may receive a common SCI-1 (e.g., common resources in the first RP and the second RP) to indicate whether the selected RP is the first RP or the second RP. In some aspects, the first RP and the second RP may share common resources associated with sidelink control information (SCI). For example, the PSCCH carrying the SCI-1 in the first RP may share common resource elements (e.g., the same symbol(s) and/or subchannel(s)) with the PSCCH carrying the SCI-1 in the second RP. Since the slot in the first RP only carries a single SCI-1, the first RP and the second RP may share a single set of common resources associated with the SCI-1. In this manner, the first sidelink UE may decode the SCI-1 using a single set of common resource elements.

The common SCI-1 may indicate the resources (e.g., AGC symbol, PSSCH length, sub-slot length) of the selected RP. In some aspects, the SCI-1 may indicate the selected RP as a codepoint, an information element, or other suitable indicator. In some aspects, the indicator may be a binary indicator (e.g., a single bit “0” or “1”). For example, the indicator value of “0” may indicate to use the first RP, whereas an indicator of “1” may indicate to use the second RP. Alternatively, the indicator value of “0” may indicate to use the second RP, whereas an indicator of “1” may indicate to use the first RP. In some aspects, the SCI-1 may indicate the selected RP using different cyclic redundancy check (CRC) scrambling of the SCI-1. By using a common SCI-1 and indicating the dynamic PSSCH length in the SCI-1, a low capability sidelink UE may be able to decode a full slot of the first RP and a leading sub-slot of the second RP (e.g., a sub-slot of the second RP that has symbols overlapping the leading symbols of the slot). By using a common SCI-1 and indicating the dynamic PSSCH length in the SCI-1, a high capability sidelink UE monitoring both the first RP and the second RP may perform a single SCI-1 decoding.

The first sidelink UE may receive a common SCI-2 (e.g., common resources in the first RP and the second RP) to indicate whether the selected RP is the first RP or the second RP. In some aspects, the PSSCH carrying the SCI-2 in the first RP may share common resource elements (e.g., the same symbol(s) and/or subchannel(s)) with the PSSCH carrying the SCI-2 in the second RP. Since the slot in the first RP only carries a single SCI-2, the first RP and the second RP may share a single set of common resources associated with the SCI-2. In this manner, the first sidelink UE may decode the SCI-2 using a single set of common resource elements. Sharing common resources between the slot of the first RP and the leading sub-slot of the second RP for the SCI-1 and/or SCI-2 may reduce computing resources and/or power consumption in the first sidelink UE.

The first sidelink UE may need to know the number of PSSCH resources (e.g., number of symbols) carrying the common SCI-2 after the first sidelink UE decodes the common SCI-1. The common SCI-1 may include an indication (e.g., a number of symbols) of the PSSCH resources carrying the common SCI-2. The first sidelink UE may receive the indicator from the second sidelink UE to use the first RP or the second RP via the common SCI-1 or the common SCI-2. The second sidelink UE may transmit the RP indicator to the first sidelink UE via the common SCI-1 or the common SCI-2 based on the number of sub-slots in the second RP. For example, if the second RP includes two sub-slots, the RP indicator may be carried by the SCI-1. If the second RP includes more than two sub-slots, then the RP indicator may be carried by the SCI-2.

In some aspects, the first sidelink UE may monitor the first RP and/or the second RP associated with the one or more sub-slots based on an interference level associated with the second sidelink UE. The second sidelink UE may intend to transmit a communication to the first sidelink UE in an unlicensed (e.g., shared) frequency band. The first sidelink UE may be exposed to radio frequency interference from surrounding devices (e.g., other sidelink UEs, WiFi devices). The interference level may be high enough to prevent the second sidelink UE from gaining access to the COT channel at the beginning of a slot. In response, the second sidelink UE may perform one or more LBTs before the one or more sub-slots of the second RP in order to increase the probability of a successful LBT and gaining the COT. However, when the interference level is below a threshold, the second sidelink UE may be able to perform a successful LBT before the slot boundary enabling the second sidelink UE to gain the COT and transmit a communication to the first sidelink UE.

If the LBT is unsuccessful, then the second sidelink UE may wait a period of time (e.g., a backoff time period) to perform another LBT. The number of unsuccessful LBTs in a time period may indicate the LBT failure rate. When the LBT failure rate associated with the first RP (e.g., full slots comprising 13 or 14 symbols) is greater than a threshold, the second sidelink UE may select the second RP with one or more sub-slots in order to have more opportunities to perform a successful LBT. Since the LBT is performed prior to a slot boundary or a sub-slot boundary, the second RP with one or more sub-slots may increase the number of times the second sidelink UE may attempt an LBT to gain the channel. When the LBT failure rate associated with the first RP is less than or equal to the threshold, the second sidelink UE may select the first RP. In some aspects, the failure rate threshold may be pre-configured in the second sidelink UE. Additionally or alternatively, the second sidelink UE may receive an LBT failure rate threshold from a network unit. In this regard, the second sidelink UE may receive the LBT failure rate threshold via DCI, a RRC message, a PDCCH message, a PDSCH message, or other suitable communication.

In some aspects, the first sidelink UE may receive an indicator from the second sidelink UE to monitor or not monitor the second RP based on the LBT failure rate. For example, when the second sidelink UE determines that the LBT failure rate is greater than a threshold, the first sidelink UE may receive an indicator to monitor the first RP and the second RP. When the second sidelink UE determines that the LBT failure rate is less than or equal to the threshold, the first sidelink UE may receive an indicator to monitor only the first RP. In this regard, the first sidelink UE may receive the indicator to monitor the second RP from the first sidelink UE via an RRC message (e.g., an RRC reconfiguration message), an SCI-1 message, an SCI-2 message, a MAC-CE message, or other suitable communication. Additionally or alternatively, the first sidelink UE may receive an indicator from a network unit to monitor or not monitor the second RP. In this regard, the first sidelink UE may receive the indicator to monitor or not monitor the second RP from the network unit via DCI, a RRC message, a PDCCH message, a PDSCH message, or other suitable communication.

At action 840, the method 800 includes a first sidelink UE (e.g., the UE 115, the UE 120, or the UE 600) receiving, from the second sidelink UE, a communication (e.g., a PSCCH communication, a PSSCH communication, a transport block) via the first RP or the second RP based on the indicator. In this regard, the first sidelink UE may receive the communication in a slot when the first RP is indicated. The first sidelink UE may receive the communication in one or more sub-slots when the second RP is indicated. The first sidelink UE may receive the communication in the one or more sub-slots indicated by a common SCI-1 and/or common SCI-2. The first sidelink UE may receive the communication after the second sidelink has performed a successful LBT (e.g., a CAT 4 LBT, a CAT 3 LBT, or a CAT 2 LBT) prior to the slot or the sub-slot.

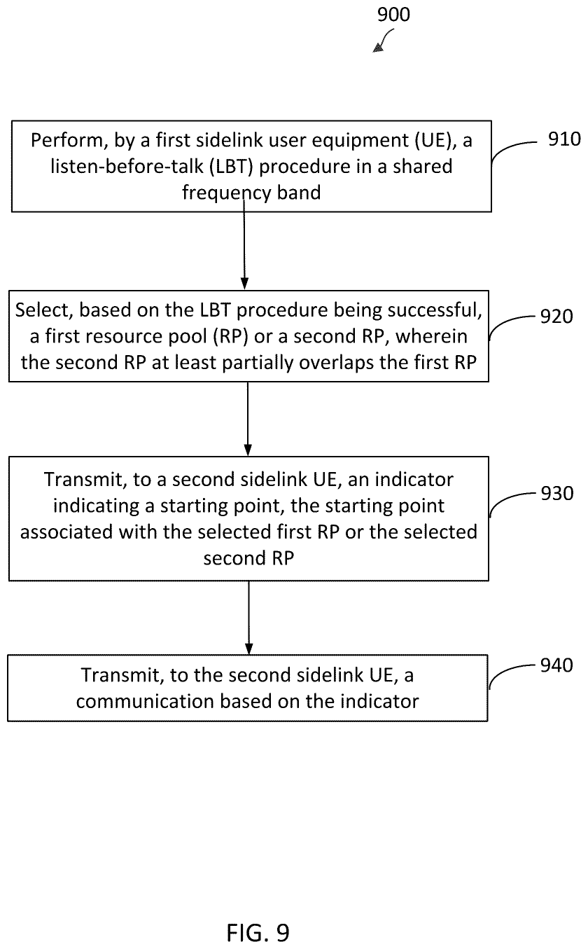

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the UE 115, the UE 120, or the UE 600, may utilize one or more components, such as the processor 602, the memory 604, the sidelink resource pool module 608, the transceiver 610, the modem 612, and the one or more antennas 616, to execute aspects of method 900. The method 900 may employ similar mechanisms as in the networks 100 and 1200 and the aspects and actions described with respect to FIGS. 3-5. As illustrated, the method 900 includes a number of enumerated aspects, but the method 900 may include additional aspects before, after, and in between the enumerated aspects. In some aspects, one or more of the enumerated aspects may be omitted or performed in a different order.

At action 910, the method 900 includes a first sidelink UE (e.g., the UE 115, the UE 120, or the UE 600) performing a listen-before-talk (LBT) procedure in a shared (e.g., an unlicensed) frequency band. The first sidelink UE may intend to transmit a communication to a second sidelink UE in an unlicensed (e.g., a shared) frequency band. The first sidelink UE may be exposed to radio frequency interference from surrounding devices (e.g., other sidelink UEs, WiFi devices). The interference level may be high enough to prevent the first sidelink UE from gaining access to the COT channel at the beginning of a slot. In response, the first sidelink UE may perform one or more LBTs before the one or more sub-slots of a second RP in order to increase the probability of a successful LBT and gaining the COT. However, when the interference level is below a threshold, the first sidelink UE may be able to perform a successful LBT before the slot boundary enabling the first sidelink UE to gain the COT and transmit a communication to the second sidelink UE.

If the LBT is unsuccessful, then the first sidelink UE may wait a period of time (e.g., a backoff time period) to perform another LBT. The number of unsuccessful LBTs in a time period may indicate an LBT failure rate. When the LBT failure rate associated with the first RP (e.g., full slots comprising 13 or 14 symbols) is greater than a threshold, the first sidelink UE may select the second RP with one or more sub-slots in order to have more opportunities to perform a successful LBT. Since the LBT is performed prior to a slot boundary or a sub-slot boundary, the second RP with one or more sub-slots may increase the number of times the first sidelink UE may attempt an LBT to gain the channel. When the LBT failure rate associated with the first RP is less than or equal to the threshold, the first sidelink UE may select the first RP. In some aspects, the failure rate threshold may be pre-configured in the first sidelink UE. Additionally or alternatively, the first sidelink UE may receive an LBT failure rate threshold from a network unit. In this regard, the first sidelink UE may receive the LBT failure rate threshold via DCI, a RRC message, a PDCCH message, a PDSCH message, or other suitable communication.

At action 920, the method 900 includes a first sidelink UE (e.g., the UE 115, the UE 120, or the UE 600) selecting, based on the LBT procedure being successful, a first resource pool (RP) or a second RP, wherein the second RP at least partially overlaps the first RP. The second sidelink UE may monitor the first RP associated with a slot. The second sidelink UE may receive a configured grant (e.g., a dynamic grant) indicating the first RP from a network unit (e.g., the BS 105, the RU 1240, the DU 1230, the CU 1210, or the network unit 700). In this regard, the second sidelink UE may operate in sidelink mode 1 and receive the configured grant for the first RP in an RRC message and/or a DCI message (e.g., a DCI-3 message, a DCI-1 message). The first RP may be associated with one or more slots. The first RP may indicate time/frequency resources allocated to the second sidelink UE. The frequency resources may include a frequency spectrum, a frequency band, a frequency sub-band, a frequency subchannel, resource elements, resource blocks, and/or a frequency interlace.

The second sidelink UE may monitor a second resource pool (RP) associated with one or more sub-slots. The second sidelink UE may receive a configured grant (e.g., a dynamic grant) indicating the second RP from a network unit (e.g., the BS 105, the RU 1240, the DU 1230, the CU 1210, or the network unit 700). In this regard, the second sidelink UE may operate in sidelink mode 1 and receive the configured grant for the second RP in an RRC message and/or a DCI message (e.g., a DCI-3 message, a DCI-1 message). The second RP may be associated with one or more sub-slots and/or slots. In some aspects, a single configured grant may indicate the first RP and the second RP. In some aspects, a first configured grant may indicate the first RP and a second configured grant may indicate the second RP. The second RP may indicate time/frequency resources associated with one or more sub-slots allocated to the second sidelink UE. The time resources may include one or more sub-slots. The frequency resources may include a frequency spectrum, a frequency band, a frequency sub-band, a frequency subchannel, resource elements, resource blocks, and/or a frequency interlace.

In some aspects, a slot may be partitioned into sub-slots such that each sub-slot occupies multiple symbols within the slot. For example, a slot may include 2, 3, 4, or more sub-slots. In some instances, a slot may include 14 symbols. A sub-slot may occupy 2, 3, 4, 5, 6, or more symbols. In some aspects, each sub-slot may occupy contiguous symbols (e.g., symbols 0-6 or symbols 7-13) within the slot. By partitioning a slot into sub-slots the first UE may increase the number of potential starting positions of a COT based on increasing the number of LBT procedures that may be performed per slot.

In some aspects, the second RP may at least partially overlap (e.g., partially overlap in time) the first RP. For example, the one or more sub-slots may overlap only with symbols of the slot of the first RP. In other words, no symbols of the sub-slot of the second RP are outside the symbols of the slot of the first RP. The one or more sub-slots of the second RP may overlap at least one leading symbol of the slot of the first RP. In some aspects, all symbols of the sub-slot of the second RP overlap with the leading symbols of the slot of the first RP. For example, the sub-slot of the second RP may occupy symbol indexes 0 to x that overlap with symbol indexes 0 to x of the slot of the first RP. In some aspects, the one or more sub-slots of the second RP overlap at least one trailing symbol of the slot of the first RP. For example, the sub-slot of the second RP may occupy symbol indexes x to 13 that overlap with symbol indexes x to 13 of the slot of the first RP. In some aspects, the one or more sub-slots of the second RP may overlap at least one trailing symbol of the slot of the first RP and at least one leading symbol of an adjacent slot. For example, the leading symbols of the sub-slot of the second RP may overlap with the trailing symbols of the slot of the first RP while the trailing symbols of the sub-slot of the second RP may overlap the leading symbols of another slot adjacent to the slot of the first RP.

Additionally or alternatively, the first RP may include a first slot and the second RP may include a second slot. The leading symbols of the second slot may overlap with the trailing symbols of the first slot while the trailing symbols of the second slot may overlap the leading symbols of a third slot adjacent to the first slot.

In some aspects, the second sidelink UE may simultaneously monitor the first RP associated with the slot and the second RP associated with the one or more sub-slots for a PSCCH communication (e.g., an SCI in the PSCCH communication). In some aspects, the second sidelink UE may simultaneously monitor the first RP associated with the slot and the second RP associated with the one or more sub-slots based on a number of the one or more sub-slots. The second RP may include one or more sub-slots. The second sidelink UE may be configured with a capability to monitor all of the one or more sub-slots. For example, the second sidelink UE may be configured with computing resources (e.g., CPU capability, memory capability, etc.) and/or power resources (e.g., battery power, line power, etc.) sufficient to monitor all of the one or more sub-slots of the second RP. In some aspects, the second sidelink UE may not be configured with sufficient computing resources and/or power resources to monitor all of the one or more sub-slots in the second RP. For example, the second sidelink UE may be configured with computing resources sufficient to only monitor one of the sub-slots.

In some aspects, the first RP and the second RP may share common resources associated with a physical sidelink feedback channel (PSFCH). For example, the PSFCH carrying HARQ feedback in the first RP may share common time resources (e.g., the same symbol(s) and/or subchannel(s)) with the PSFCH carrying HARQ feedback in the second RP. The first RP and the second RP may share common a common PSFCH periodicity. In some aspects, the first RP and the second RP may share common frequency resources for the PSFCH. Additionally or alternatively, the frequency resources of the PSFCH in the first RP may be multiplexed (e.g., frequency division multiplexed) with the frequency resources of the PSFCH in the second RP. The first sidelink UE and the second sidelink UE may receive an indication of the first RP and the second RP in a configured grant (e.g., a dynamic configured grant) from a network unit (e.g., the BS 105, the RU 1240, the DU 1230, the CU 1210, or the network unit 700). The configured grant may indicate the resource elements of the common SCI-1, the common SCI-2, and/or the common PSFCH.

At action 930, the method 900 includes a first sidelink UE (e.g., the UE 115, the UE 120, or the UE 600) may transmit, to a second sidelink UE, an indicator indicating the selected first RP or the selected second RP. The first sidelink UE may select the first RP or the second RP based on an LBT failure rate. The first sidelink UE may transmit the indicator indicating the selected RP to the second sidelink UE. In this regard, the first sidelink UE may transmit a common SCI-1 (e.g., common resources in the first RP and the second RP) to indicate whether the selected RP is the first RP or the second RP.

In some aspects, the first RP and the second RP may share common resources associated with sidelink control information (SCI). For example, the PSCCH carrying the SCI-1 in the first RP may share common resource elements (e.g., the same symbol(s) and/or subchannel(s)) with the PSCCH carrying the SCI-1 in the second RP. Since the slot in the first RP only carries a single SCI-1, the first RP and the second RP may share a single set of common resources associated with the SCI-1. In this manner, the second sidelink UE may decode the SCI-1 using a single set of common resource elements.

The common SCI-1 may indicate the resources (e.g., AGC symbol, PSSCH length, sub-slot length) of the selected RP. In some aspects, the SCI-1 may indicate the selected RP as a codepoint, an information element, or other suitable indicator. In some aspects, the indicator may be a binary indicator (e.g., a single bit “0” or “1”). For example, the indicator value of “0” may indicate to use the first RP, whereas an indicator of “1” may indicate to use the second RP. Alternatively, the indicator value of “0” may indicate to use the second RP, whereas an indicator of “1” may indicate to use the first RP. In some aspects, the SCI-1 may indicate the selected RP using different cyclic redundancy check (CRC) scrambling of the SCI-1. By using a common SCI-1 and indicating the dynamic PSSCH length in the SCI-1, a low capability sidelink UE may be able to decode a full slot of the first RP and a leading sub-slot of the second RP (e.g., a sub-slot of the second RP that has symbols overlapping the leading symbols of the slot). By using a common SCI-1 and indicating the dynamic PSSCH length in the SCI-1, a high capability sidelink UE monitoring both the first RP and the second RP may perform a single SCI-1 decoding.

The first sidelink UE may transmit a common SCI-2 (e.g., common resources in the first RP and the second RP) to indicate whether the selected RP is the first RP or the second RP. In some aspects, the PSSCH carrying the SCI-2 in the first RP may share common resource elements (e.g., the same symbol(s) and/or subchannel(s)) with the PSSCH carrying the SCI-2 in the second RP. Since the slot in the first RP only carries a single SCI-2, the first RP and the second RP may share a single set of common resources associated with the SCI-2. In this manner, the second sidelink UE may decode the SCI-2 using a single set of common resource elements. Sharing common resources between the slot of the first RP and the leading sub-slot of the second RP for the SCI-1 and/or SCI-2 may reduce computing resources and/or power consumption in the second sidelink UE.

The second sidelink UE may need to know the number of PSSCH resources (e.g., number of symbols) carrying the common SCI-2 after the second sidelink UE decodes the common SCI-1. The common SCI-1 may include an indication (e.g., a number of symbols) of the PSSCH resources carrying the common SCI-2. The first sidelink UE may transmit the indicator from the second sidelink UE to use the first RP or the second RP via the common SCI-1 or the common SCI-2. The first sidelink UE may transmit the RP indicator to the second sidelink UE via the common SCI-1 or the common SCI-2 based on the number of sub-slots in the second RP. For example, if the second RP includes two sub-slots, the RP indicator may be carried by the SCI-1. If the second RP includes more than two sub-slots, then the RP indicator may be carried by the SCI-2.

In some aspects, the first sidelink UE may transmit an indicator to the second sidelink UE to monitor or not monitor the second RP based on the LBT failure rate. For example, when the first sidelink UE determines that the LBT failure rate is greater than a threshold, the first sidelink UE may transmit an indicator to monitor the first RP and the second RP. When the first sidelink UE determines that the LBT failure rate is less than or equal to the threshold, the first sidelink UE may transmit an indicator to monitor only the first RP. In this regard, the first sidelink UE may transmit the indicator to monitor the second RP to the first sidelink UE via an RRC message (e.g., an RRC reconfiguration message), an SCI-1 message, an SCI-2 message, a MAC-CE message, or other suitable communication. Additionally or alternatively, the second sidelink UE may receive an indicator from a network unit to monitor or not monitor the second RP. In this regard, the second sidelink UE may receive the indicator to monitor or not monitor the second RP from the network unit via DCI, a RRC message, a PDCCH message, a PDSCH message, or other suitable communication.

At action 940, the method 900 includes a first sidelink UE (e.g., the UE 115, the UE 120, or the UE 600) transmitting, to the second sidelink UE, a communication based on the indicator. The first sidelink UE may transmit a PSCCH communication, a PSSCH communication, and/or a transport block via the first RP or the second RP based on the indicator. In this regard, the first sidelink UE may transmit the communication in a slot when the first RP is indicated. The first sidelink UE may transmit the communication in one or more sub-slots when the second RP is indicated. The first sidelink UE may transmit the communication in the one or more sub-slots indicated by a common SCI-1 and/or common SCI-2. The first sidelink UE may transmit the communication after the first sidelink has performed a successful LBT (e.g., a CAT 4 LBT, a CAT 3 LBT, or a CAT 2 LBT) prior to the slot or the sub-slot. For example, the first sidelink UE may transmit the communication in the next sub-slot after the first sidelink has performed a successful LBT.

Further aspects of the present disclosure include the following:

Aspect 1 includes a method of wireless communication performed by a first user sidelink equipment (UE), the method comprising monitoring a first resource pool (RP) associated with a slot; monitoring a second RP associated with one or more sub-slots, wherein the second RP at least partially overlaps the first RP; receiving, from a second sidelink UE, an indicator indicating a starting point, the starting point associated with the first RP or the second RP; and receiving, from the second sidelink UE, a communication based on the indicator.

Aspect 2 includes the method of aspect 1, further comprising receiving, from a network unit, a configured grant indicating at least one of the first RP or the second RP.

Aspect 3 includes the method of any of aspects 1-2, wherein the monitoring the second RP associated with the one or more sub-slots is based on a number of the one or more sub-slots.

Aspect 4 includes the method of any of aspects 1-3, wherein the monitoring the second RP associated with the one or more sub-slots is based on an interference level associated with the second sidelink UE.

Aspect 5 includes the method of any of aspects 1-4, wherein at least one of the one or more sub-slots overlap only with symbols of the slot; the one or more sub-slots overlap at least one leading symbol of the slot; the one or more sub-slots overlap at least one trailing symbol of the slot; or the one or more sub-slots overlap at least one trailing symbol of the slot and at least one leading symbol of an adjacent slot.

Aspect 6 includes the method of any of aspects 1-5, wherein the first RP and the second RP share common resources associated with sidelink control information (SCI).

Aspect 7 includes the method of any of aspects 1-6, wherein the first RP and the second RP share common resources associated with a physical sidelink feedback channel (PSFCH).

Aspect 8 includes the method of any of aspects 1-7, further comprising receiving, from a network unit, an indicator indicating to monitor the second RP, wherein the monitoring the second RP associated with the one or more sub-slots is based on the indicator.

Aspect 9 includes a method of wireless communication performed by a first sidelink user equipment (UE), the method comprising performing a listen-before-talk (LBT) procedure in a shared frequency band; selecting, based on the LBT procedure being successful, a first resource pool (RP) or a second RP, wherein the second RP at least partially overlaps the first RP; transmitting, to a second sidelink UE, an indicator indicating a starting point, the starting point associated with the selected first RP or the selected second RP; and transmitting, to the second sidelink UE, a communication based on the indicator.

Aspect 10 includes the method of aspect 9, wherein the first RP is associated with a slot; and he second RP is associated with one or more sub-slots.

Aspect 11 includes the method of any of aspects 9-10, wherein the selecting the first RP or the second RP comprises selecting the first RP or the second RP further based on a time period between the successful LBT procedure and a boundary of the slot: or a time period between the successful LBT procedure and a boundary of a next sub-slot of the one or more slots after the successful LBT procedure.

Aspect 12 includes the method of any of aspects 9-11, further comprising receiving, from the second sidelink UE, a capability indicator indicating a capability level of the second sidelink UE, wherein the selecting the first RP or the second RP is based on the capability indicator.

Aspect 13 includes the method of any of aspects 9-12, wherein at least one of the first RP and the second RP share common resources associated with sidelink control information (SCI); or the first RP and the second RP share common resources associated with a physical sidelink feedback channel (PSFCH).

Aspect 14 includes the method of any of aspects 9-13, wherein the selecting the first RP or the second RP comprises selecting the second RP based on a LBT failure rate associated with the first sidelink UE satisfying a threshold.

Aspect 15 includes the method of any of aspects 9-14, wherein the selecting the first RP or the second RP comprises selecting the second RP; and further comprising transmitting, to the second sidelink UE, an RP indicator indicating the selection of the second RP via at least one of a radio resource control (RRC) message; sidelink control information (SCI); or a medium access control element (MAC-CE).

Aspect 16 includes a non-transitory computer-readable medium storing one or more instructions for wireless communication, the one or more instructions comprising one or more instructions that, when executed by one or more processors of a first sidelink UE, cause the first sidelink UE to perform any one of aspects 1-8.

Aspect 17 includes a non-transitory computer-readable medium storing one or more instructions for wireless communication, the one or more instructions comprising one or more instructions that, when executed by one or more processors of a first sidelink UE cause the first sidelink UE to perform any one of aspects 9-15.

Aspect 18 includes a first sidelink user equipment (UE) comprising one or more means to perform any one or more of aspects 1-8.

Aspect 19 includes a first sidelink UE comprising one or more means to perform any one or more of aspects 9-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a first sidelink user equipment (UE), the method comprising:
monitoring a first resource pool (RP) associated with a slot;
monitoring a second RP associated with one or more sub-slots, wherein the second RP at least partially overlaps the first RP;
receiving, from a second sidelink UE, an indicator indicating a selection of the first RP or the second RP; and
receiving, from the second sidelink UE, a communication via the first RP or the second RP based on the indicator.

2. The method of claim 1, further comprising:
receiving, from a network unit, a configured grant indicating resources associated with at least one of the first RP or the second RP.

3. The method of claim 1, wherein the monitoring the second RP associated with the one or more sub-slots is based on a number of the one or more sub-slots.

4. The method of claim 1, wherein the monitoring the second RP associated with the one or more sub-slots is based on an interference level associated with the second sidelink UE.

5. The method of claim 1, wherein at least one of:
the one or more sub-slots overlap only with symbols of the slot;
the one or more sub-slots overlap at least one leading symbol of the slot;
the one or more sub-slots overlap at least one trailing symbol of the slot; or
the one or more sub-slots overlap at least one trailing symbol of the slot and at least one leading symbol of an adjacent slot.

6. The method of claim 1, wherein the first RP and the second RP share common resources associated with sidelink control information (SCI).

7. The method of claim 1, wherein the first RP and the second RP share common resources associated with a physical sidelink feedback channel (PSFCH).

8. The method of claim 1, further comprising:
receiving, from a network unit, an indicator indicating to monitor the second RP, wherein the monitoring the second RP associated with the one or more sub-slots is based on the indicator.

9. A method of wireless communication performed by a first sidelink user equipment (UE), the method comprising:
performing a listen-before-talk (LBT) procedure in a shared frequency band;
selecting, based on the LBT procedure being successful, a first resource pool (RP) or a second RP, wherein the second RP at least partially overlaps the first RP;
transmitting, to a second sidelink UE, an indicator indicating the selected first RP or the selected second RP; and
transmitting, to the second sidelink UE, a communication based on the indicator.

10. The method of claim 9, wherein:
the first RP is associated with a slot; and
the second RP is associated with one or more sub-slots.

11. The method of claim 10, wherein the selecting the first RP or the second RP comprises selecting the first RP or the second RP further based on:
a time period between the successful LBT procedure and a boundary of the slot: or
a time period between the successful LBT procedure and a boundary of a next sub-slot of the one or more slots after the successful LBT procedure.

12. The method of claim 9, further comprising receiving, from the second sidelink UE, a capability indicator indicating a capability level of the second sidelink UE, wherein the selecting the first RP or the second RP is based on the capability indicator.

13. The method of claim 9, wherein at least one of:
the first RP and the second RP share common resources associated with sidelink control information (SCI); or
the first RP and the second RP share common resources associated with a physical sidelink feedback channel (PSFCH).

14. The method of claim 9, wherein the selecting the first RP or the second RP comprises selecting the second RP based on a LBT failure rate associated with the first sidelink UE satisfying a threshold.

15. The method of claim 9, wherein the selecting the first RP or the second RP comprises selecting the second RP; and
further comprising transmitting, to the second sidelink UE, an RP indicator indicating the selection of the second RP via at least one of:
a radio resource control (RRC) message;
sidelink control information (SCI); or
a medium access control control element (MAC-CE).

16. A first sidelink user equipment (UE) comprising:
a memory;
a transceiver; and
at least one processor coupled to the memory and the transceiver, wherein the first sidelink UE is configured to:
monitor a first resource pool (RP) associated with a slot;
monitor a second RP associated with one or more sub-slots, wherein the second RP at least partially overlaps the first RP;
receive, from a second sidelink UE, an indicator indicating a selection of the first RP or the second RP; and
receive, from the second sidelink UE, a communication via the first RP or the second RP based on the indicator.

17. The first sidelink UE of claim 16, wherein the first sidelink UE is further configured to:
receive, from a network unit, a configured grant indicating at least one of the first RP or the second RP.

18. The first sidelink UE of claim 16, wherein the first sidelink UE is further configured to:
monitor the second RP associated with the one or more sub-slots based on a number of the one or more sub-slots.

19. The first sidelink UE of claim 16, wherein the first sidelink UE is further configured to:
monitor the second RP associated with the one or more sub-slots based on an interference level associated with the second sidelink UE.

20. The first sidelink UE of claim 16, wherein at least one of:
the one or more sub-slots overlap only with symbols of the slot;
the one or more sub-slots overlap at least one leading symbol of the slot;
the one or more sub-slots overlap at least one trailing symbol of the slot; or
the one or more sub-slots overlap at least one trailing symbol of the slot and at least one leading symbol of an adjacent slot.

21. The first sidelink UE of claim 16, wherein the first RP and the second RP share common resources associated with sidelink control information (SCI).

22. The first sidelink UE of claim 16, wherein the first RP and the second RP share common resources associated with a physical sidelink feedback channel (PSFCH).

23. The first sidelink UE of claim 16, wherein the first sidelink UE is further configured to:
receive, from a network unit, an indicator indicating to monitor the second RP; and
monitor the second RP associated with the one or more sub-slots based on the indicator.

24. A first sidelink user equipment (UE) comprising:
a memory;
a transceiver; and
at least one processor coupled to the memory and the transceiver, wherein the first sidelink UE is configured to:
perform a listen-before-talk (LBT) procedure in a shared frequency band;
select, based on the LBT procedure being successful, a first resource pool (RP) or a second RP, wherein the second RP at least partially overlaps the first RP;
transmit, to a second sidelink UE, an indicator indicating the selected first RP or the selected second RP; and
transmit, to the second sidelink UE, a communication based on the indicator.

25. The first sidelink UE of claim 24, wherein:
the first RP is associated with a slot; and
the second RP is associated with one or more sub-slots.

26. The first sidelink UE of claim 25, wherein the first sidelink UE is further configured to:
select the first RP or the second RP further based on:
a time period between the successful LBT procedure and a boundary of the slot: or
a time period between the successful LBT procedure and a boundary of a next sub-slot of the one or more slots after the successful LBT procedure.

27. The first sidelink UE of claim 24, wherein the first sidelink UE is further configured to:
receive, from the second sidelink UE, a capability indicator indicating a capability level of the second sidelink UE; and
select the first RP or the second RP based on the capability indicator.

28. The first sidelink UE of claim 24, wherein at least one of:
the first RP and the second RP share common resources associated with sidelink control information (SCI); or
the first RP and the second RP share common resources associated with a physical sidelink feedback channel (PSFCH).

29. The first sidelink UE of claim 24, wherein the first sidelink UE is further configured to:
select the second RP based on a LBT failure rate associated with the first sidelink UE satisfying a threshold.

30. The first sidelink UE of claim 24, wherein the first sidelink UE is further configured to:
select the second RP; and
transmit, to the second sidelink UE, an RP indicator indicating the selection of the second RP via at least one of:
a radio resource control (RRC) message;
sidelink control information (SCI); or
a medium access control control element (MAC-CE).
